(19) United States
(12) Patent Application Publication
(10) Pub. No.: US 2011/0069752 A1
(43) Pub. Date: Mar. 24, 2011

(54) MOVING IMAGE ENCODING/DECODING METHOD AND APPARATUS WITH FILTERING FUNCTION CONSIDERING EDGES

(76) Inventors: Takashi Watanabe, Fuchu-shi (JP); Goki Yasuda, Kawasaki-shi (JP); Naofumi Wada, Yokohama-shi (JP); Takeshi Chujoh, Kawasaki-shi (JP); Akiyuki Tanizawa, Kawasaki-shi (JP)

(21) Appl. No.: 12/887,549

(22) Filed: Sep. 22, 2010

Related U.S. Application Data
(63) Continuation of application No. PCT/JP09/58265, filed on Apr. 27, 2009.

(30) Foreign Application Priority Data
Apr. 30, 2008 (JP) 2008-118884

(51) Int. Cl. H04N 7/26

(52) U.S. Cl. 375/240.03; 375/240.25; 375/E07.027; 375/E07.14

(57) ABSTRACT

According to one embodiment, a moving image encoding method is disclosed. The method can generate a prediction error image based on a difference between an input moving image and a predicted image. The method can execute transform and quantization on the prediction error image to generate quantized transformation coefficients. The method can generate edge information which indicates an attribute of an edge in a local decoded image corresponding to an encoded image. The method can generate, based on the edge information, control information associated with application of a filter to a decoded image at a decoding side. The method can set filter coefficients for the filter based on the control information. In addition, the method can encode the quantized transformation coefficients and filter coefficient information indicating the filter coefficients to output encoded data.

### CROSS REFERENCE TO RELATED APPLICATIONS

This is a Continuation Application of PCT Application No. PCT/JP2009/058265, filed Apr. 27, 2009, which was published under PCT Article 21(2) in Japanese.

This application is based upon and claims the benefit of priority from Japanese Patent Application No. 2008-118884, filed Apr. 30, 2008; the entire contents of which are incorporated herein by reference.

### FIELD

Embodiments described herein relate generally to a moving image encoding/decoding method and apparatus, in which the filter coefficients of a filter is set at the encoding side to transmit filter coefficient information, and is received and used at the decoding side.

### BACKGROUND

In moving image encoding/decoding apparatuses for executing orthogonal transform, for each pixel block, on a prediction error image as the difference between an input moving image and a predicted image, and quantizing the transformation coefficients, image quality degradation called blocking artifact will occur in decoded images. In view of this, G. Bjontegaard, “Deblocking filter for 4×4 based coding”, ITU-T Q.15/SG16 VCEG document, Q15-J-27, May 2000 (Document 1) discloses a deblocking filter for applying a low-pass filter to a block boundary to make the blocking artifact not highly visible and acquire a better visible image.

Since the deblocking filter is used in a loop employed in encoding/decoding apparatuses, it is also called a loop filter. The deblocking filter can reduce the blocking artifact of a reference image used for prediction. In particular, it is expected that this filter can enhance the encoding efficiency in a highly compressed bit-rate band in which blocking artifact is liable to occur.

Filters applied to only output images at the decoding side, unlike the loop filter, are called post filters. S. Wittmann and T. Wedi, “Post-filter SEI message for 4:4:4 coding”, JVT of ISO/IEC MPEG & ITU-T VCEG, JVT-S030, April 2006 (Document 2), discloses a moving image encoding/decoding apparatus using a post filter. In Document 2, at the encoding side, the filter coefficients of the post filter is set, and this filter coefficients data (first coefficients data) is encoded and transmitted. At the decoding side, the encoded data is received and decoded to generate second filter coefficients data, and a decoded image is subjected to post filter processing using a filter having its filter coefficients set in accordance with the second filter coefficients data. As a result, an output image is produced.

In Document 2, by setting, at the encoding side, the filter coefficients to reduce an error between an input moving image and its decoded image, the quality of an output image obtained at the decoding side by applying the post filter can be enhanced.

The deblocking filter disclosed in Document 1 executes processing for reducing visibly conspicuous degradation by blurring the block boundary. Accordingly, the deblocking filter does not necessarily reduce an error in the decoded image with respect to the input image. In some cases, fine texture may be lost to reduce the image quality. Further, since the deblocking filter is a low-pass filter, if an edge exists in a filter applying range, the image quality will significantly be degraded. Therefore, in Document 1, only adjustment of the degree of filtering in accordance with the degree of the blocking artifact is executed, and filtering processing considering the edge is not executed. As a result, when an area containing the edge is filtered, filtering is executed using a pixel of a pixel value that significantly differs from that of a target pixel, whereby the effect of improving image quality is inevitably reduced.

Also in Document 2, filtering considering edges is not executed, and hence image quality may well be degraded when filtering is executed in an area containing edges. Furthermore, in the method of Document 2, the encoding side sets a filter so as to reduce an error between an input image and a decoded image, and transmits information indicating the set filter. In this structure, a large number of filters suitable for various edge shapes existing in a filter applying range can be designed. However, the fact that information indicating a large number of filters is sent means that the coding bits is increased, which results in the reduction of the encoding efficiency.

### BRIEF DESCRIPTION OF THE DRAWINGS

FIG. 1 is a block diagram illustrating a moving image encoding apparatus according to a first embodiment;

FIG. 2 is a block diagram illustrating a filter generating unit 107;

FIG. 3 is a flowchart useful in explaining the operation of the filter generating unit 107;

FIG. 4A is a view illustrating examples of filter-applied pixels;

FIG. 4B is a view illustrating filter coefficients set for the respective filter-applied pixels when the rotation angle of a filter is 0°;

FIG. 5A is a view illustrating examples of filter-applied pixels;

FIG. 5B is a view illustrating filter coefficients set for the respective filter-applied pixels when the rotation angle of the filter is 90 ;

FIG. 6A is a view illustrating examples of filter-applied pixels;

FIG. 6B is a view illustrating filter coefficients set for the respective filter-applied pixels after the filter is rotated through 45°;

FIG. 7A is a view illustrating examples of filter-applied pixels obtained before pixel replacement is executed;

FIG. 7B is a view illustrating examples of filter-applied pixels obtained after pixel replacement is executed on the filter-applied pixels of FIG. 7A;

FIG. 8A is a view illustrating examples of filter-applied pixels obtained before pixel replacement is executed;

FIG. 8B is a view illustrating examples of filter-applied pixels obtained after pixel replacement is executed on the filter-applied pixels of FIG. 8A;

FIG. 9 is a block diagram illustrating the syntax structure of encoded data in the first embodiment;

FIG. 10 is a view illustrating an example of the loop filter data syntax shown in FIG. 9;

FIG. 11 is a view illustrating another example of the loop filter data syntax shown in FIG. 9;

FIG. 12 is a block diagram illustrating a moving image decoding apparatus corresponding to the encoding apparatus of FIG. 1;

FIG. 13 is a block diagram illustrating a filter processing unit 205;

FIG. 14 is a flowchart useful in explaining the operation of the filter processing unit 205;

FIG. 15 is a block diagram illustrating a moving image encoding apparatus according to a second embodiment;

FIG. 16 is a block diagram illustrating a filter-generating/processing unit 301;

FIG. 17 is a flowchart useful in explaining the operation of the filter-generating/processing unit 301;

FIG. 18 is a block diagram illustrating a moving image decoding apparatus corresponding to the encoding apparatus of FIG. 15; and

FIG. 19 is a block diagram illustrating another moving image decoding apparatus corresponding to the encoding apparatus of FIG. 15.

### DETAILED DESCRIPTION

In general, according to one embodiment, a moving image encoding method is disclosed. The method can generate a prediction error image based on a difference between an input moving image and a predicted image. The method can execute transform and quantization on the prediction error image to generate quantized transformation coefficients. The method can generate edge information which indicates an attribute of an edge in a local decoded image corresponding to an encoded image. The method can generate, based on the edge information, control information associated with application of a filter to a decoded image at a decoding side. The method can set filter coefficients for the filter based on the control information. In addition, the method can encode the quantized transformation coefficients and filter coefficient information indicating the filter coefficients to output encoded data.

Embodiments will be described with reference to the accompanying drawings.

### FIRST EMBODIMENT

(Moving Image Encoding Apparatus)

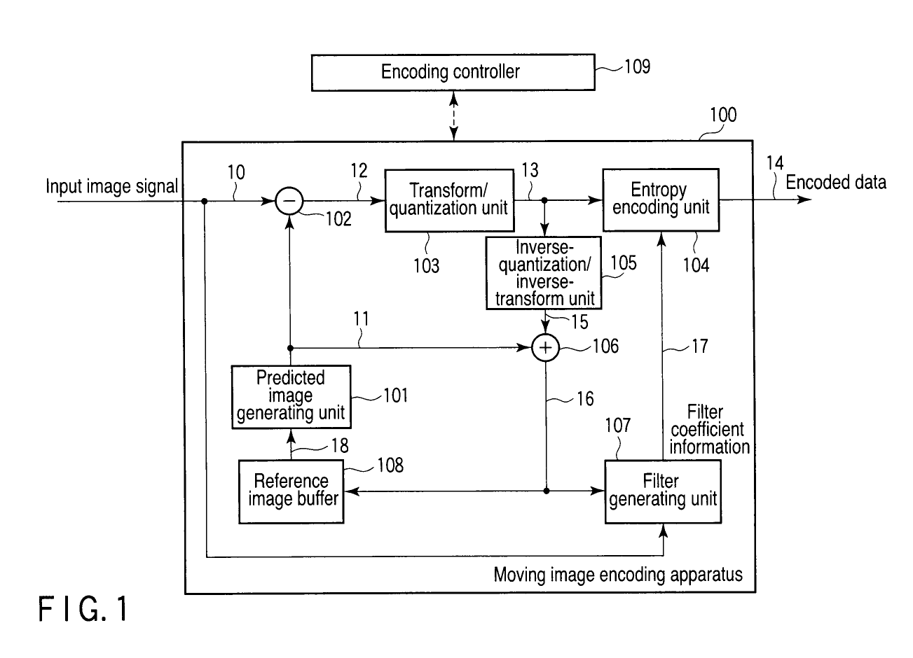

As shown in FIG. 1, a moving image encoding apparatus 100 according to a first embodiment comprises a predicted image generating unit 101, a subtractor (prediction error generating unit) 102, a transform/quantization unit 103, an entropy encoding unit 104, an inverse-quantization/inverse-transform unit 105, an adder 106, a filter generating unit 107, and a reference image buffer 108. The moving image encoding apparatus 100 is controlled by an encoding controller 109.

The predicted image generating unit 101 acquires a reference image signal 18 from the reference image buffer 108 and executes preset prediction processing, thereby outputting a predicted image signal 11. As the prediction processing, for example, time-domain prediction based on motion prediction, motion compensation, etc., or space-domain prediction based on an already encoded pixel in an image, may be executed.

The prediction error generating unit 102 calculates the difference between an input image (moving image) signal 10 and the predicted image (moving image) signal 11 to thereby generate a prediction error image signal 12. The prediction error image signal 12 is input to the transform/quantization unit 103.

The transform/quantization unit 103 firstly executes transform processing on the prediction error image signal 12. In this case, orthogonal transform, such as discrete cosine transform (DCT), is executed to generate transformation coefficients. Alternatively, wavelet transform or independent component analysis may be executed to generate the transformation coefficients. Subsequently, the transform/quantization unit 103 quantizes the transformation coefficients to form quantized transformation coefficients 13, based on quantization parameters set in the encoding controller 109, described later, and outputs the quantized transformation coefficients 13 to the entropy encoding unit 104 and also to the inverse-quantization/inverse-transform unit 105.

The inverse-quantization/inverse-transform unit 105 executes inverse quantization on the quantized transformation coefficients 13 in accordance with the quantization parameters set in the encoding controller 109. Thereafter, the inverse-quantization/inverse-transform unit 105 executes, on the inversely quantized transformation coefficients, inverse orthogonal transform, such as inverse discrete cosine transform (IDCT), which is inverse to the transform executed in the transform/quantization unit 103, thereby generating a prediction error image signal 15.

The adder 106 adds up the prediction error image signal 15 generated by the inverse-quantization/inverse-transform unit 105 and the predicted image signal 11 generated by the predicted image generating unit 101, thereby generating a local decoded image signal 16 corresponding to an already encoded image signal included in the input image signal 10. The filter generating unit 107 outputs filter coefficient information 17 based on the local decoded image signal 16 and the input image signal 10. The filter generating unit 107 will be described later in detail.

The reference image buffer 108 temporarily stores the local decoded image signal 16 as a reference image signal 18. The reference image signal 18 stored in the reference image buffer 108 is referred to when the predicted image generating unit 101 generates the predicted image signal 11.

The entropy encoding unit 104 executes entropy encoding (such as Huffman encoding or arithmetic encoding) on various encoding parameters, such as the quantized transformation coefficients 13, the filter coefficient information 17, prediction mode information, block size switch information, motion vectors and the quantization parameters, and outputs encoded data 14.

The encoding controller 109 executes feedback control and quantization control of the coding bits executed, and mode control, thereby controlling the entire encoding processing.

A description will now be given of the outline of the processing executed by the moving image encoding apparatus 100 of the first embodiment. A series of encoding processes described below is a general encoding process executed in moving image encoding that is so-called hybrid encoding in which prediction processing and transform processing are executed.

Firstly, when the input image signal 10 is input to the moving image encoding apparatus 100, the prediction error generating unit (subtractor) 102 subtracts, from the input image signal 10, the predicted image signal 11 generated by the predicted image generating unit 101, thereby generating the prediction error image signal 12. The prediction error image signal 12 is supplied to the transform/quantization unit 103, where it is subjected to transform and quantization, thereby generating the quantized transformation coefficients 13. The quantized transformation coefficients 13 are encoded by the entropy encoding unit 104.

The quantized transformation coefficients 13 are also input to the inverse-quantization/inverse-transform unit 105, where inverse transform and inverse quantization are executed to generate the prediction error image signal 15. The prediction error image signal 15 is added, in the adder 106, to the predicted image signal 11 output from the predicted image generating unit 101, thereby generating the local decoded image signal 16.

(Filter Generating Unit)

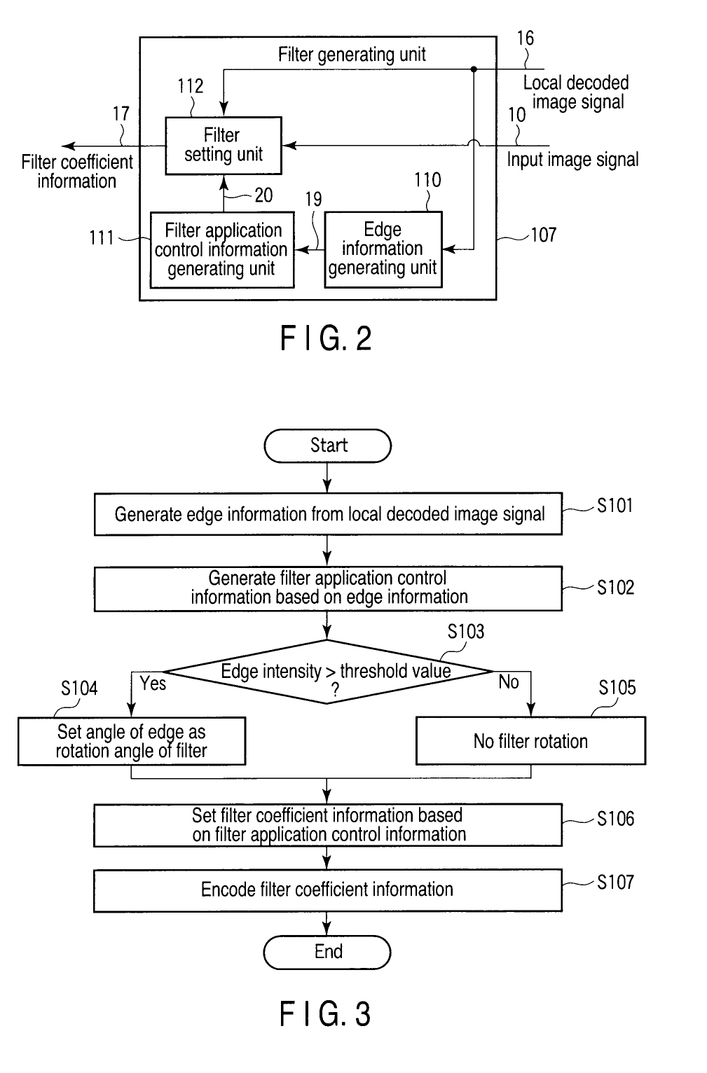

Referring to FIG. 2, the filter generating unit 107 will be described in detail. As shown in FIG. 2, the filter generating unit 107 comprises an edge information generating unit 110, a filter application control information generating unit 111, and a filter setting unit 112.

The edge information generating unit 110 generates edge information 19 from the local decoded image signal 16. The method of generating the edge information 19 will be described later. The filter application control information generating unit 111 generates filter application control information 20 based on the edge information 19. The filter application control information 20 is control information indicating how a filter should be applied to a decoded image at the decoding side. Its detailed content will be described later. The generated filter application control information 20 is input to the filter setting unit 112. The filter setting unit 112 sets filter coefficient information 17 based on the local decoded image signal 16, the input image signal 10 and the generated filter application control information 20. Particulars of the method of setting the filter coefficient information 17 will be described later. The thus-set filter coefficient information 17 is input to the entropy encoding unit 104.

Subsequently, the filter generating unit 107 will be described in more detail with reference to FIGS. 2 and 3. FIG. 3 shows the procedure of processing executed by the filter generating unit 107.

In the filter generating unit 107, firstly, the edge information generating unit 110 generates the edge information 19 from the local decoded image signal 16 (step S101). The edge information 19 indicates the attributes of an edge in an image, such as the intensity of the edge, the orientation of the edge, the shape of the edge, and the difference between the edge and each neighboring pixel. In this embodiment, the intensity and orientation of the edge are used as the edge attributes. To generate the edge intensity and orientation, a general edge detection method, such as Sobel operator or Prewitt operator, can be utilized.

After that, the filter application control information generating unit 111 generates filter application control information 20 based on the edge information 19 (step S102). The filter application control information 20 indicates control parameters for use in a preset filter application method. The filter application method is a method of applying a filter to a decoded image (including a locally decoded image) as a filter target. Namely, the filter application method is a method associated with a process executed on the filter itself or filter-applied pixels when filtering is executed. As the filter application method, a method of rotating the filter, a method of replacing filter-applied pixels in an image, or the like, is used. At this time, the filter application control information 20 is information for enabling the filter rotation or the pixel replacement. Specific examples will be described below.

(Filter Rotation 1)

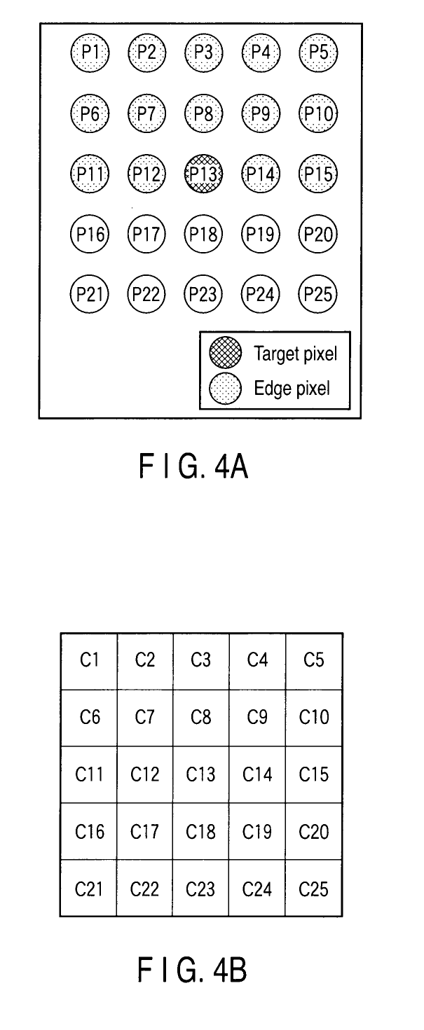

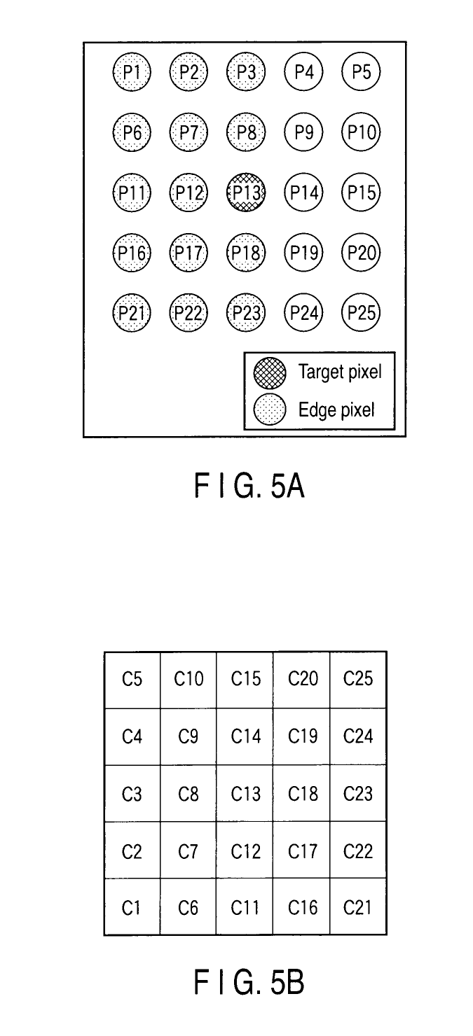

A description will be given of the case where “filter rotation” is executed to apply a filter. Filter rotation means rotation of the filter along an edge in an image. In this case, the filter application control information generating unit 111 generates, as the filter application control information 20, information indicating the rotation angle through which the filter rotates. Referring now to FIGS. 4A, 4B, 5A and 5B, an example of the filter rotation will be described.

When the filter rotation angle is 0°, i.e., when no filter rotation is executed, if filter coefficients are set, as shown in FIG. 4B, for filter-applied pixels shown in FIG. 4A, filter coefficients C1, C2, . . . , correspond to pixels P1, P2, . . . , respectively. In contrast, if the filter rotation angle is 90°, if filter coefficients are set, as shown in FIG. 5B, for filter-applied pixels shown in FIG. 5A, the filter coefficients C1, C2, . . . , correspond to pixels P21, P16, . . . , respectively. Thus, generation of the filter application control information 20 is equivalent to determination of pixels that correspond to filter coefficients, i.e., equivalent to the determination of the correspondence between filter coefficients and pixels. Accordingly, the filter application control information 20 may be, for example, table information showing the correspondence between filter coefficients and pixels.

Referring back to FIG. 3, to determine the filter rotation angle, firstly, it is determined whether the edge intensity indicated by the edge information 19 is higher than a threshold value (step S103). If the edge intensity is higher than the threshold value, the angle corresponding to the edge orientation indicated by the edge information 19 is set as the filter rotation angle (step S104). The edge orientation is defined as an orientation along which pixel values do not greatly change. In contrast, if the edge intensity is not higher than the threshold value, the filter-applied pixels are regarded as the pixels of a flat portion of the image, and no filter rotation is executed (i.e., the rotation angle of the filter is set to 0°) (step S105). The filter application control information generating unit 111 outputs, as the filter application control information 20, the filter rotation angle determined at step S104 or S105.

The technical significant of the filter rotation is that the features of image components within the filter application range are made to be similar to each other. For instance, in the image of FIG. 4A, the edge orientation is horizontal. In this case, in general, pixels arranged horizontal do not greatly change in their pixel values, and pixels arranged vertical greatly change in their pixel values. Therefore, a filter that has a low-pass characteristic along the horizontal axis, and a high-pass characteristic along the vertical axis is suitable. Assume here that the filter having these characteristics has filter coefficients as shown in FIG. 4B.

In contrast, in the image shown in FIG. 5A, the edge orientation is vertical. In this case, in general, pixels arranged vertical do not greatly change in their pixel values, and pixels arranged horizontal greatly change in their pixel values. Therefore, a filter that has a low-pass characteristic along the vertical axis, and a high-pass characteristic along the horizontal axis is suitable. Therefore, for the image shown in FIG. 5A, the filter is rotated through 90° from the position shown in FIG. 4B, as is shown in FIG. 5B. By thus rotating the filter in accordance with the edge orientation, appropriate filter designing and application become possible.

(Filter Rotation 2)

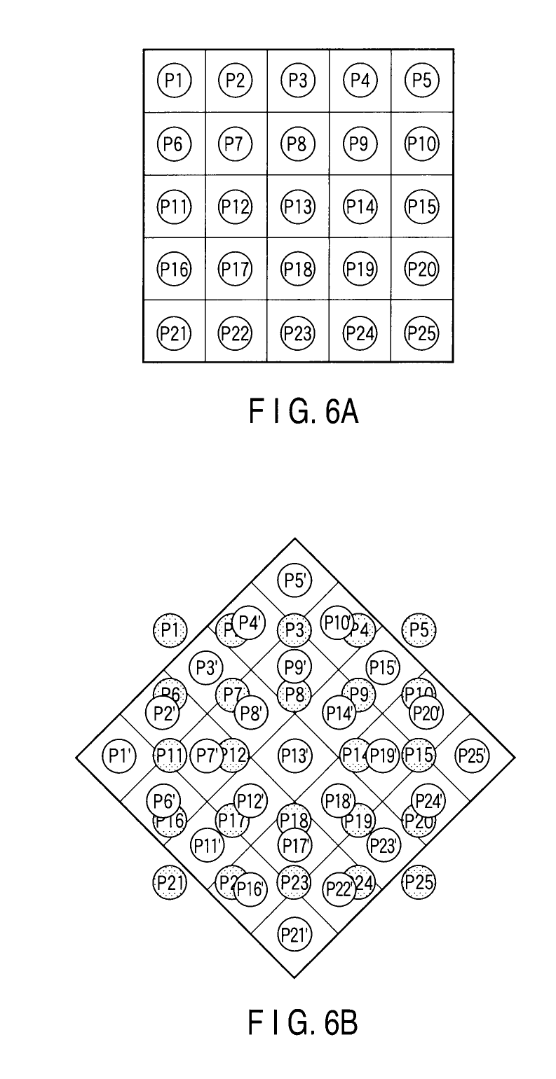

When the filter is rotated, if a filter-applied pixel does not exist at an integer pixel position on a target image, a method of using, for example, a pixel located at an integer pixel position closest to the filter-applied pixel, or a method of generating, by interpolation, a pixel located at a sub-pixel position on the target image corresponding to the filter-applied pixel, can be used. For instance, when the filter rotation angle is 0° as shown in FIG. 6A, filtering is executed using the pixels located at all integer pixel positions denoted by P1 to P25. In contrast, when the filter rotation angle is 45° as shown in FIG. 6B, filtering need be executed using the pixels denoted by P1′ to P25′. Regarding, for example, pixel P2′ located at a sub-pixel position, filtering is executed using, instead of pixel P2′, integer pixel P6 closest to pixel P2′, or using pixel P2′ itself calculated by interpolating adjacent pixels.

(Pixel Replacement 1)

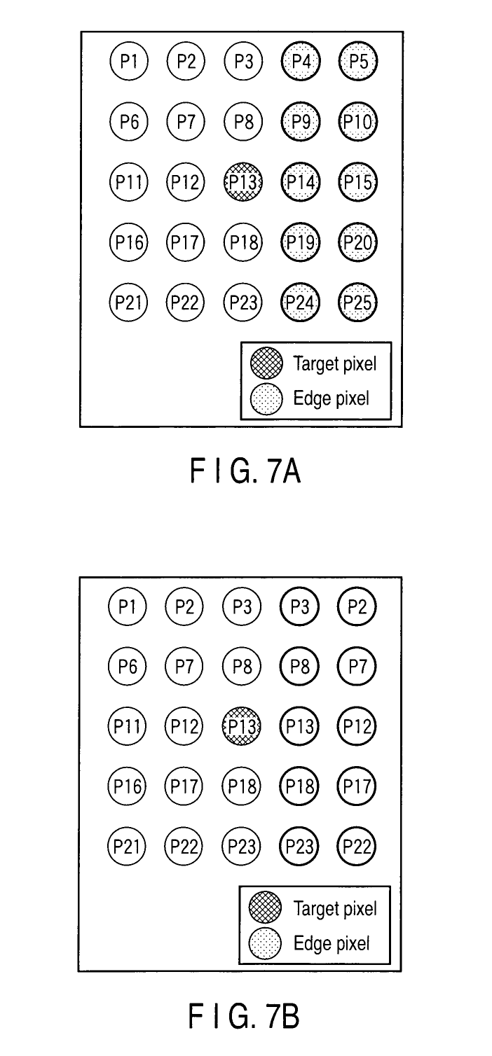

A description will be given of the case where “pixel replacement” is utilized as a filter application method. In particular, a method of applying a filter after folding pixels corresponding to an edge of an image will be described. If, for example, a filter-applied range including target pixel P13 contains a vertical edge denoted by edge pixels P4, P5, P9, P10, P14, P15, P19, P20, P24 and P25 as shown in FIG. 7A, a filter is applied to target pixel P13 after horizontally folding pixels as shown in FIG. 7B.

Namely, the filter is applied to target pixel P13 after edge pixels P4, P5, P9, P10, P14, P15, P19, P20, P24 and P25 are replaced with non-edge pixels P3, P2, P8, P7, P13, P12, P18, P17, P23 and P22, respectively, which are located symmetrical to the edge pixels with respect to the boundary between the edge portion and the flat portion.

In this case, information indicating the correspondence between the edge pixels and the non-edge pixels located symmetrical to the edge pixels with respect to the boundary is output as filter application control information 20.

Thus, when a filter is applied to a certain target pixel, an edge pixel having a pixel value significantly differing from that of the target pixel is not used, and a non-edge pixel is used instead, thereby suppressing reduction in image quality improving effect that may occur if the edge pixel is used.

(Pixel Replacement 2)

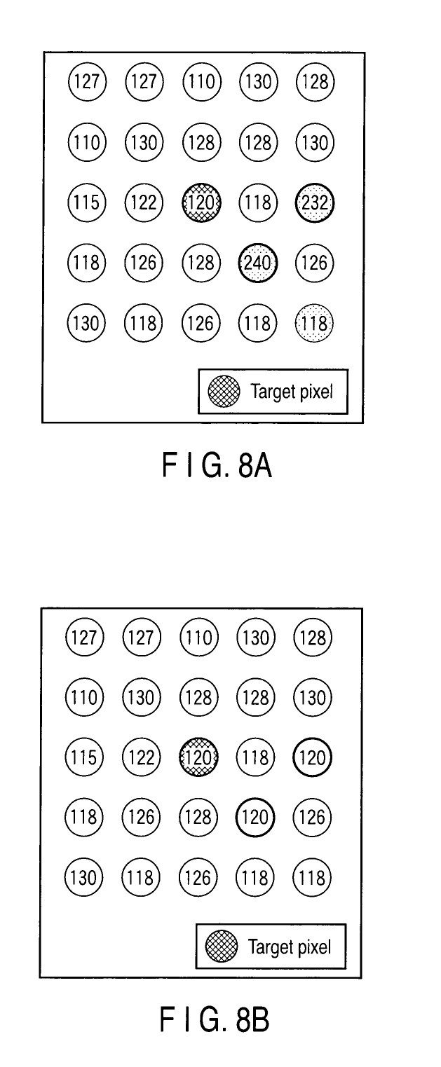

Another filter application method using “pixel replacement” will be described. In this case, a pixel (called a singular pixel) that exists in a filter-applied range including a target pixel and has a pixel value significantly differing from that of the target pixel is detected based on the differences between the singular pixel and its adjacent pixels, or the difference between the singular pixel and the target pixel, or based on the intensity of an edge. After that, the thus-detected singular pixel is replaced with the target pixel or an adjacent pixel, and then a filter is applied to the target pixel. More specifically, if a threshold value for the difference between the singular pixel and the target pixel is set to “100,” firstly, singular pixels having pixel values of “240” and “232” are detected as shown in FIG. 8A, and replaced with a target pixel or a pixel near the target pixel, as is shown in FIG. 8B. In this case, the difference between each of the singular pixels and the target pixel exceeds the threshold value of “100.” After that, filtering is executed.

Further, in this case, position (pixel position) information on the to-be-replaced singular pixels is output as the filter application control information 20.

As described above, when a certain target pixel is filtered, if a singular pixel having a pixel value significantly different from that of the certain target pixel is not used, reduction of image quality improving effect due to the singular pixel can be avoided.

The filter setting unit 112 determines a to-be-filtered pixel based on the filter application control information 20, and then sets the filter coefficient information 17 (step S106). The filter setting unit 112 receives the input image signal 10 and the local decoded image signal 16, as well as the filter application control information 20. Using, for example, the two-dimensional Wiener filter generally used for image restoration, the filter setting unit 112 sets filter coefficients that can minimize the mean square error between the input image signal 10 and the image signal obtained by filtering the local decoded image signal 16 based on the filter application control information 20. The filter setting unit 112 outputs the set filter coefficients as the filter coefficient information 17. If the filter size is variable as described later, the filter coefficient information 17 may contain a value indicating the filter size.

The filter coefficient information 17 is encoded by the entropy encoding unit 104, and is multiplexed into a bit stream, along with the quantized transformation coefficients 13, prediction mode information, block size switching information, motion vectors, quantization parameters, etc. The resultant bit stream is transmitted to a moving image decoding unit 200, described later (step S107).

(Syntax Structure)

A description will now be given of an example of a syntax structure employed in the embodiment for encoding the filter coefficient information 17. In the example below, assume that the filter coefficient information 17 is transmitted per slice.

Syntax mainly comprises three parts, such as high-level syntax 1900, slice-level syntax 1903, and macro block-level syntax 1907. The high-level syntax 1900 comprises syntax information of upper layers higher than the slice level. The slice-level syntax 1903 comprises information necessary per slice. The macro block-level syntax 1907 comprises transformation coefficients data, prediction mode information, motion vectors, etc., required for each macro block.

Each of the high-level syntax 1900, the slice-level syntax 1903, and macro block-level syntax 1907 includes detailed syntax. Namely, the high-level syntax 1900 includes sequence level syntax and picture level syntax, such as sequence parameter set syntax 1901 and picture parameter set syntax 1902. The slice-level syntax 1903 includes slice header syntax 1904, slice data syntax 1905, loop filter data syntax 1906, etc. The macro block-level syntax 1907 includes macro block-layer syntax 1908, macro block prediction syntax 1909, etc.

The loop filter data syntax 1906 comprises the filter coefficient information 17 as parameters associated with the filter of the embodiment, as is shown in FIG. 10. In FIG. 10, filter_coeff[cy] [cx] indicates the filter coefficient information 17, and is a set of coefficients for a two-dimensional filter, and filter_size_y and filter size_x are values for determining the tap length of the filter. Alternatively, a one-dimensional filter may be used instead of the two-dimensional one. In this case, the filter coefficient information 17 is changed as shown in FIG. 11. Further, although in this embodiment, a value or values indicating a tap length of the filter are included in the syntax, a preset fixed value may be used. In the case of using the fixed value, however, it should be noted that similar values need to be used in both the moving image encoding apparatus 100, and the moving image decoding apparatus 200 described later.

(Moving Image Decoding Apparatus)

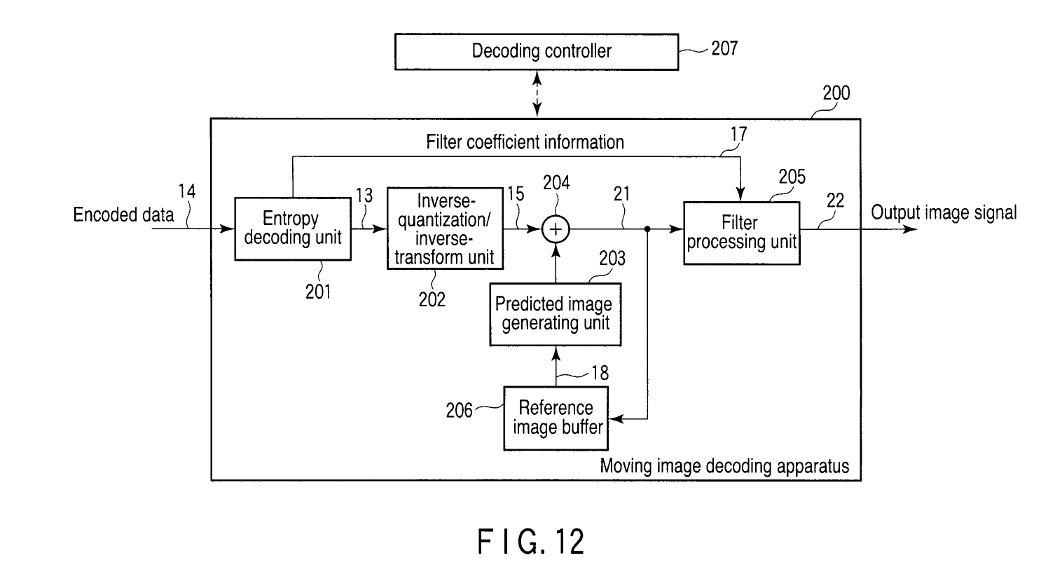

Referring then to FIG. 12, a description will be given of the moving image decoding apparatus 200 corresponding to the above-described moving image encoding apparatus 100. As shown in FIG. 12, the moving image decoding apparatus 200 of the first embodiment comprises an entropy decoding unit 201, an inverse-quantization/inverse-transform unit 202, a predicted image generating unit 203, an adder 204, a filter processing unit 205, and a reference image buffer 206. The moving image decoding apparatus 200 is controlled by a decoding controller 207.

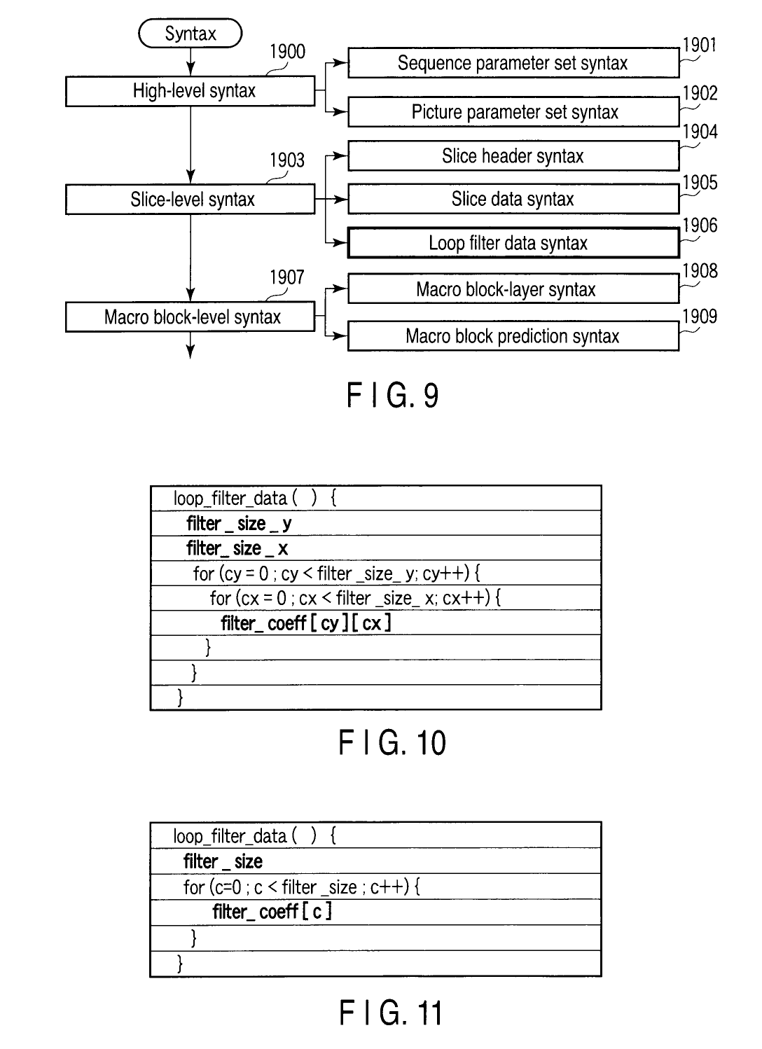

In accordance with the syntax structure shown in FIG. 9, the entropy decoding unit 201 sequentially decodes code sequences of the encoded data 14 corresponding to the high-level syntax 1900, the slice-level syntax 1903, and macro block-level syntax 1907, thereby restoring the quantized transformation coefficients 13, the filter coefficient information 17, etc. The inverse-quantization/inverse-transform unit 202 executes inverse transform and inverse quantization corresponding to the orthogonal transform and quantization executed in the moving image encoding apparatus 100. Specifically, the inverse-quantization/inverse-transform unit 202 executes inverse quantization processing on the quantized transformation coefficients 13 to generate transformation coefficients, and then executes, on the transformation coefficients, transform inverse to the transform executed by the transform/quantization unit 103, such as inverse orthogonal transform (e.g., inverse discrete cosine transform), thereby generating a prediction error image signal 15. Further, if the transform/quantization unit 103 of the moving image encoding apparatus 100 executes Wavelet transform and quantization, the inverse-quantization/inverse-transform unit 202 executes inverse Wavelet transform and inverse quantization.

The predicted image generating unit 203 acquires a decoded reference image signal 18 from the reference image buffer 206, and executes preset prediction processing on the signal to thereby output a predicted image signal 11. As the prediction processing, for example, time-domain prediction based on motion compensation, or space-domain prediction based on a decoded pixel in an image, is executed. At this time, it should be noted that prediction processing corresponding to the prediction processing executed in the moving image encoding apparatus 100 is executed.

The adder 204 adds up the prediction error image signal 15 and the predicted image signal 11 to produce a decoded image signal 21. The decoded image signal 21 is input to the filter processing unit 205.

The filter processing unit 205 filters the decoded image signal 21 based on the filter coefficient information 17, and outputs a restored image signal 22. The filter processing unit 205 will be described later in detail. The reference image buffer 206 temporarily stores, as the reference image signal 18, the decoded image signal 21 acquired from the filter processing unit 205. The reference image signal 18 stored in the reference image buffer 206 is referred to when the predicted image generating unit 203 generates the predicted image signal 11.

The decoding controller 207 executes, for example, decoding timing control to thereby control the entire decoding processing.

A description will now be given of the outline of the processing executed by the moving image decoding apparatus 200 of the embodiment. A series of decoding processes, described below, is a general decoding process corresponding to moving image encoding, so-called hybrid encoding, in which prediction processing and transform processing are executed.

Firstly, when the encoded data 14 is input to the moving image decoding apparatus 200, it is decoded by the entropy decoding unit 201, whereby the prediction mode information, block size switch information, motion vectors, quantization parameters, etc., are reproduced in accordance with the syntax structure shown in FIG. 9, in addition to the transformation coefficients 13 and the filter coefficient information 17.

Subsequently, the quantized transformation coefficients 13 output from the entropy decoding unit 201 are supplied to the inverse-quantization/inverse-transform unit 202, where they are inversely quantized in accordance with the quantization parameters set in the decoding controller 207, and the resultant coefficients are subjected to inverse orthogonal transform, such as inverse discrete cosine transform, thereby restoring the prediction error image signal 15. The prediction error image signal 15 is added by the adder 204 to the predicted image signal 11 generated by the predicted image generating unit 203, whereby the decoded image signal 21 is generated.

(Filter Processing Unit)

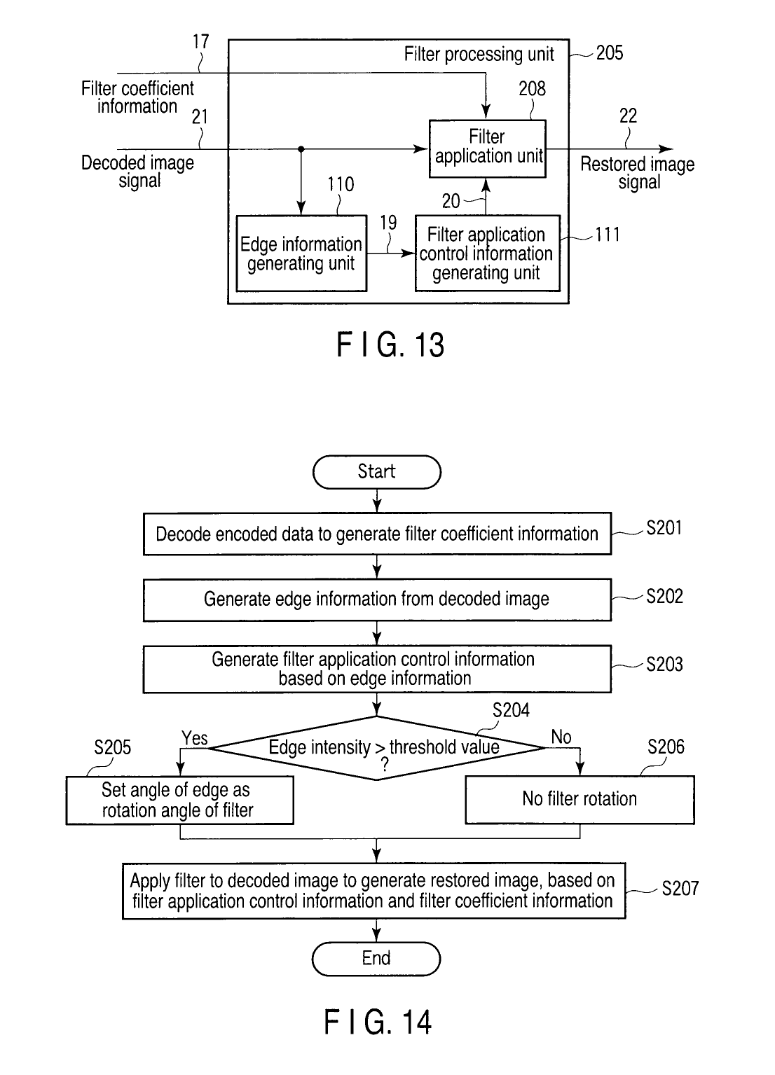

Referring to FIG. 13, the filter processing unit 205 will be described in detail.

As shown in FIG. 13, the filter processing unit 205 comprises an edge information generating unit 110, a filter application control information generating unit 111, and a filter application unit 208.

The edge information generating unit 110 generates edge information 19 from the decoded image signal 21.

The filter application control information generating unit 111 generates filter application control information 20 based on the edge information 19. The filter application control information 20 is input to the filter application unit 208.

It should be noted that the edge information generating unit 110 and the filter application control information generating unit 111 execute the same processes as the corresponding units of the moving image encoding apparatus 100. By virtue of this structure, the moving image decoding apparatus 200 produces the same filter application control information 20 as that of the moving image encoding apparatus 100.

The filter application unit 208 acquires the decoded image signal 21, and the filter coefficient information 17 decoded by the entropy decoding unit 201, and executes filtering on the decoded image signal 21 based on the filter application control information 20, thereby generating the restored image signal 22. The generated restored image signal 22 is output as an output image signal at the timing determined by the decoding controller 207.

Referring then to FIGS. 13 and 14, will be described in more detail. FIG. 14 shows the processing procedure of the filter processing unit 205.

In the filter processing unit 205, firstly, the entropy decoding unit 201 executes entropy decoding on the filter coefficient information 17 based on the syntax structure of FIG. 9 (step S201). The loop filter data syntax 1906 belonging to the slice-level syntax 1903 comprises the filter coefficient information 17 as a parameter associated with the filter in the embodiment, as is shown in FIG. 10. In FIG. 10, filter_coeff[cy] [cx] indicates the filter coefficient information 17, and is a set of coefficients for a two-dimensional filter, and filter_size_y and filter_size_x are values for determining the tap length of the filter. Alternatively, a one-dimensional filter may be used instead of the two-dimensional one. In this case, the filter coefficient information 17 is changed as shown in FIG. 11. Further, although in this embodiment, a value or values indicating the tap length of the filter are included in the syntax, a preset fixed value may be used. In the case of using the fixed value, however, it should be noted that similar values need to be used in both the moving image encoding apparatus 100, and the moving image decoding apparatus 200 described later.

After that, the edge information generating unit 110 generates edge information 19 from the decoded image signal 21 (step S202). For the generation of the edge information 19 from the decoded image signal 21, it is necessary to use the same method as that used in the moving image encoding apparatus 100.

Subsequently, the filter application control information generating unit 111 generates the filter application control information 20 based on the edge information 19 (steps S203 to S206). For the generation of the filter application control information, it is necessary to use the same process as that used in the moving image encoding apparatus 100. By thus executing the same processes in the edge information generating unit 110 and the filter application control information generating unit 111 of the moving image decoding apparatus 200, as in the corresponding units of the moving image encoding apparatus 100, the filter application control methods at the encoding and decoding sides coincide with each other.

Lastly, based on the filter application control information 20, the filter application unit 208 applies, to the decoded image signal 21, a filter having its filter coefficients set in accordance with the filter coefficient information 17, thereby generating the restored image signal 22 (step S207).

The restored image signal 22 is output as an output image signal.

As described above, in the moving image encoding apparatus of the first embodiment, the filter coefficient information is set to minimize the error between the input image and the decoded image, and filtering is executed based on this filter coefficient information. As a result, the quality of the output image is enhanced. Further, since the filter application method considering edges is used, reduction of image quality improving effect can be suppressed.

In the moving image encoding apparatus 100 and the moving image decoding apparatus 200 of the first embodiment, the local decoded image signal 16 is input to the filter setting unit to generate the filter coefficient information 17, and filter processing is executed using the filter coefficient information 17. However, the image signal obtained after executing conventional deblocking processing may be used as the local decoded image signal 16.

### SECOND EMBODIMENT

In the first embodiment, the filter processing unit 205 of the moving image decoding apparatus 200 is a post filter. In contrast, in the second embodiment, the filter processing unit 205 is a loop filter, and the restored image signal 22 obtained after filter application is used as a reference image signal.

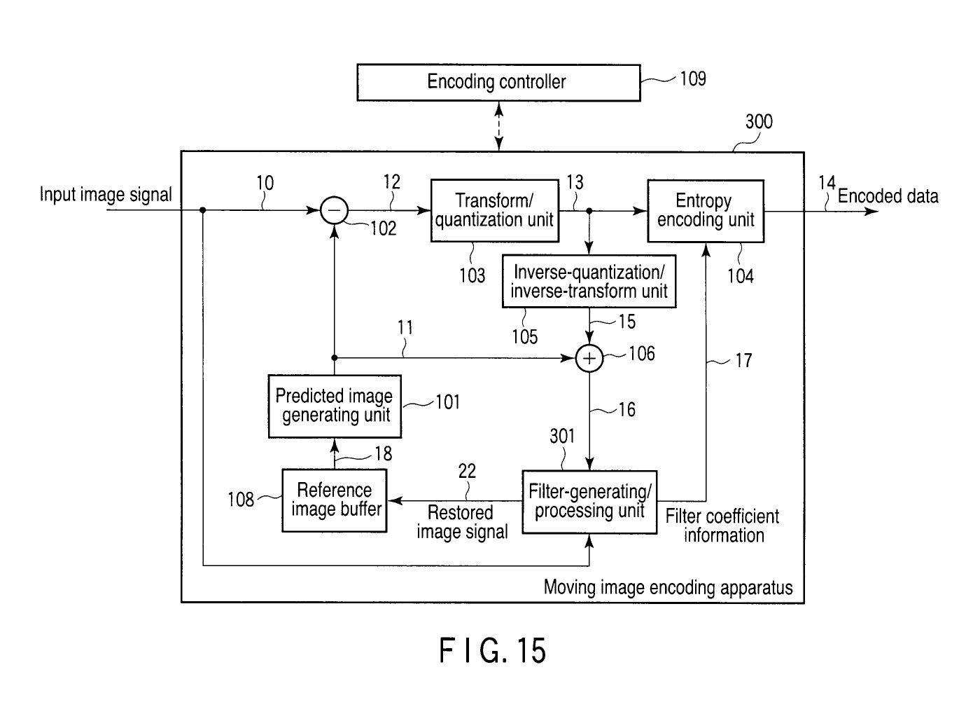

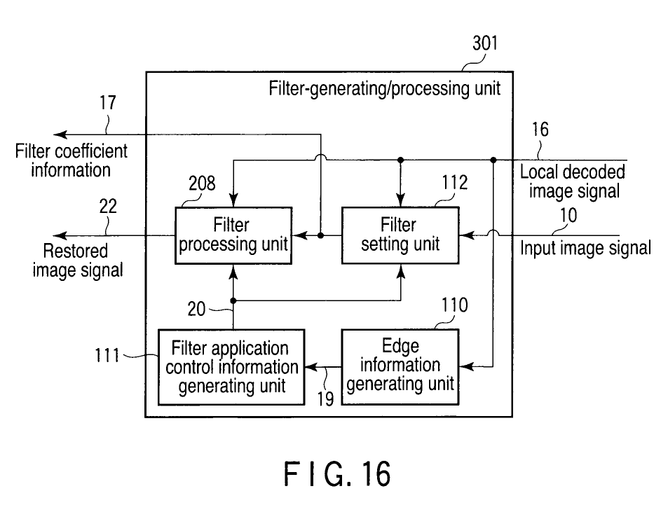

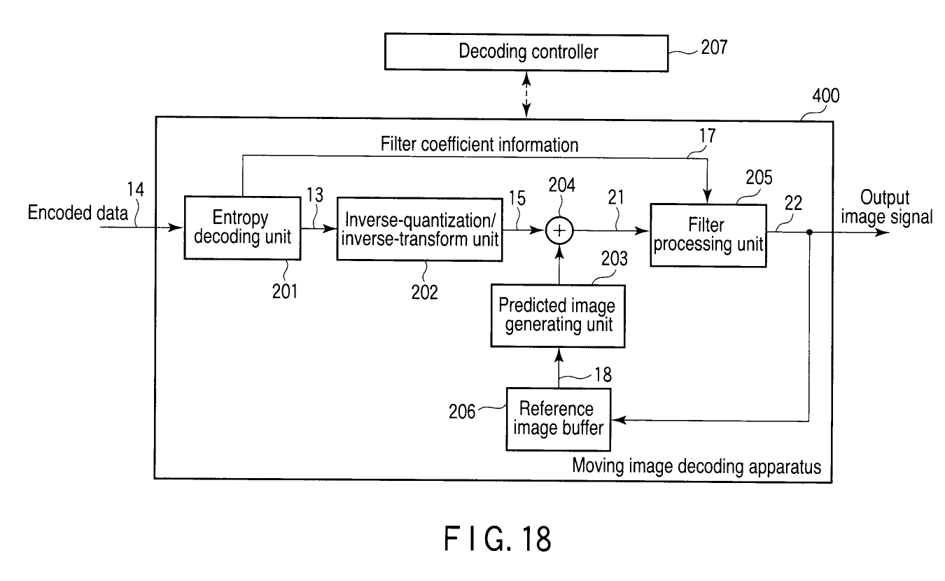

FIG. 15 shows a moving image encoding apparatus 300 according to the second embodiment. In this embodiment, the filter generation unit 107 shown in FIG. 2 and incorporated in the moving image encoding apparatus of FIG. 1 is replaced with a filter-generating/processing unit 301 shown in FIG. 16. FIG. 18 shows a moving image decoding apparatus 400 according to the second embodiment, which differs from the moving image decoding apparatus 200 of FIG. 12 in that in the former, the restored image signal 22 output from the filter processing unit 205 is input to the reference image buffer 206.

In the moving image encoding apparatus 300, the filter generating unit 107 of the moving image encoding apparatus 100 according to the first embodiment is replaced with the filter-generating/processing unit 301, and the restored image signal 22 output from the filter-generating/processing unit 301 is input to the reference image buffer 108, instead of the local decoded image signal 16 output from the adder 106. Further, as shown in FIG. 16, the filter-generating/processing unit 301 is realized by additionally incorporating the filter application unit 208 in the filter generating unit 107 of FIG. 2.

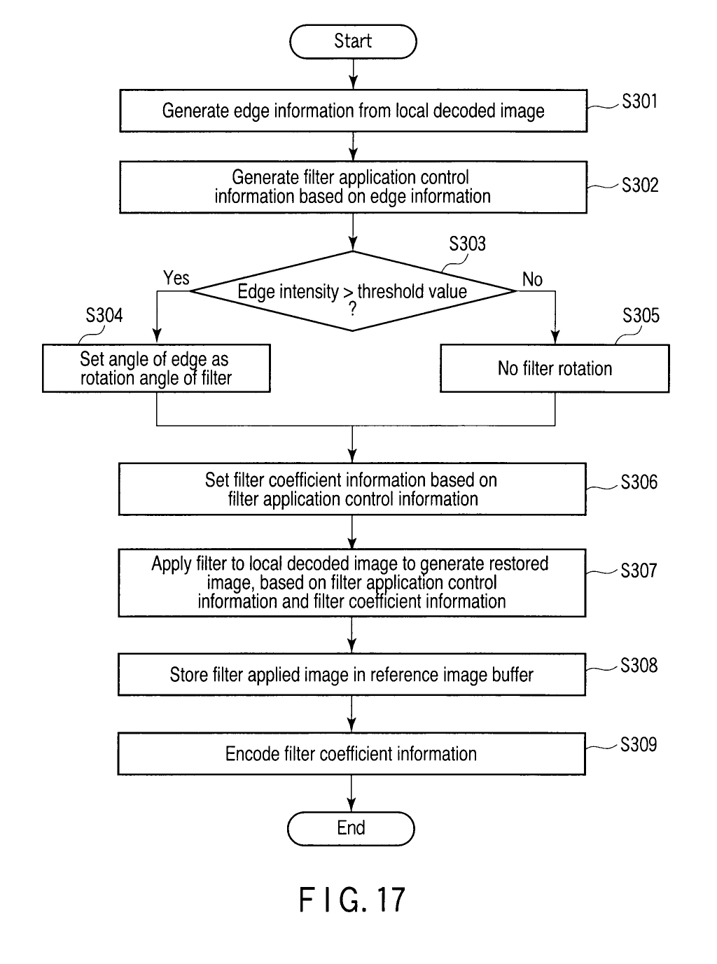

Referring now to FIGS. 15, 16 and 17, the operations of the moving image encoding apparatus 300 and the filter-generating/processing unit 301 will be described. FIG. 17 is a flowchart useful in explaining the operations associated with the filter-generating/processing unit 301 in the moving image encoding apparatus 300. Firstly, the local decoded image signal 16 is generated by the same processing as that in the moving image encoding apparatus 100, and is input to the filter-generating/processing unit 301.

In the filter-generating/processing unit 301, firstly, the edge information generating unit 110 generates the edge information 19 from the local decoded image signal 16 (step S301).

Subsequently, the filter application control information generating unit 111 generates the filter application control information 20 based on the edge information 19 (steps S302 to S305).

After that, the filter setting unit 112 acquires the local decoded image signal 16, the input signal 10 and the filter application control information 20, determines a pixel to be filtered based on the acquired filter application control information 20, and sets the filter coefficient information 17 (step S306).

The processes from step S301 to step S306 are similar to those executed by the filter generating unit 107 of the moving image encoding apparatus 100 according to the first embodiment.

Based on the set filter coefficient information 17, the filter application unit 208 applies, to the local decoded image signal 16, a filter having its coefficients set in accordance with the filter coefficient information 17, based on the filter application control information 20 thereby generating the restored image signal 22 (step S307). The generated, restored image signal 22 is stored as a reference image signal in the reference image buffer 108 shown in FIG. 15 (step S308).

Lastly, the filter coefficient information 17 is encoded by the entropy encoding unit 104, and is multiplexed into a bit stream, along with the quantized transformation coefficients 13, prediction mode information, block size switching information, motion vectors, quantization parameters, etc. The resultant bit stream is transmitted to a moving image decoding unit 400 (step S309).

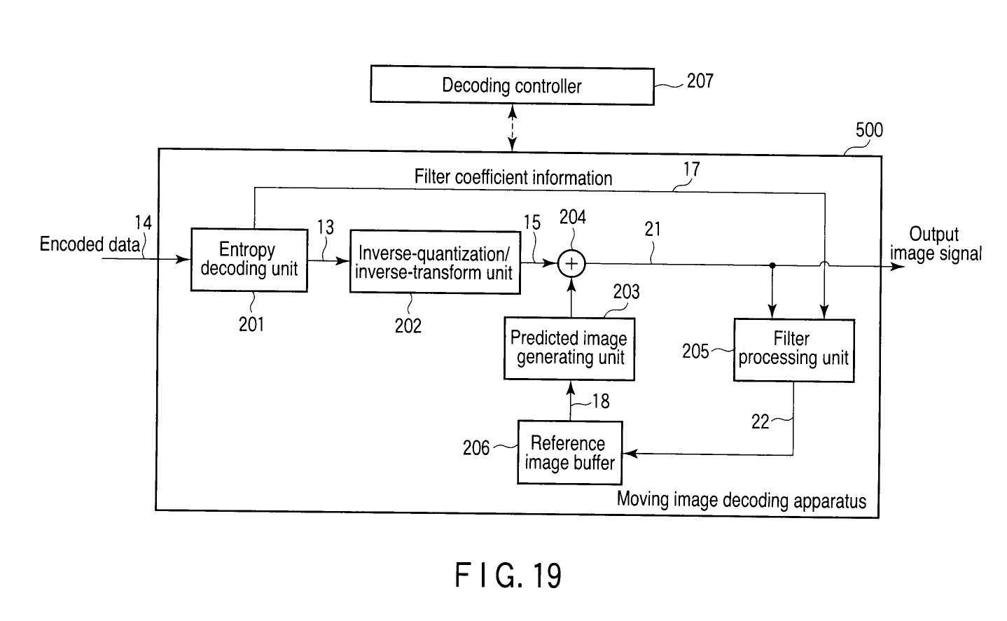

FIG. 19 shows a moving image decoding unit 500 obtained by modifying the moving image decoding unit 400 of FIG. 18. The moving image decoding unit 500 differs from the latter only in that the decoded image signal 22 is only used as a reference image signal, and the normal decoded image signal 21 is used as the output image signal.

The moving image encoding units (100, 300) and the moving image decoding units (200, 400, 500) according to the above-described embodiments can also be realized using, for example, a versatile computer as basic hardware. Namely, the predicted image generating unit 101, the prediction error generating unit 102, the transform/quantization unit 103, the entropy encoding unit 104, the inverse-quantization/inverse-transform unit 105, the adder 106, the filter generating unit 107, the reference image buffer 108, the encoding controller 109, the edge information generating unit 110, the filter application control information generating unit 111, the filter setting unit 112, the entropy decoding unit 201, the inverse-quantization/inverse-transform unit 202, the predicted image generating unit 203, the adder 204, the filter processing unit 205, the reference image buffer 206, the decoding controller 207, the filter application unit 208 and the filter-generating/processing unit 301 can be realized by causing a processor incorporated in the computer to execute programs.

In this case, the moving image encoding units and the moving image decoding units may be realized by pre-installing the above programs in the computer, or by recording them in a storage medium such as a CD-ROM or downloading them via a network, and installing them in the computer when necessary. Further, the reference image buffers 108 and 206 can be realized using a memory or a hard disk installed in or externally attached to the computer, or using storage mediums, such as a CD-R, a CD-RW, a DVD-RAM and a DVD-R.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving image encoding method comprising:
generating a prediction error image based on a difference between an input moving image and a predicted image;
executing transform and quantization on the prediction error image to generate a plurality of quantized transformation coefficients;
generating edge information which indicates an attribute of an edge in a local decoded image corresponding to an encoded image;
generating, based on the edge information, control information associated with application of a filter to a decoded image at a decoding side;
setting filter coefficients for the filter based on the control information; and
encoding the quantized transformation coefficients and filter coefficient information indicating the filter coefficients to output encoded data.

2. The method according to claim 1, further comprising:
applying the filter having the filter coefficients specified by the filter coefficient information to the local decoded image, based on the control information, to generate a restored image; and
using the restored image as a reference image to generate the predicted image.

3. The method according to claim 2, wherein
the edge information includes orientation information indicating an orientation of the edge; and
the control information includes rotation angle information indicating a rotation angle of the filter and used when the filter is rotated and applied based on the orientation information.

4. The method according to claim 3, wherein
the edge information further includes intensity information indicating an intensity of the edge; and
the rotation angle information included in the control information is used when the filter is rotated and applied to an area in which the intensity of the edge is higher than a threshold value, based on the orientation information.

5. The method according to claim 3, wherein the filter is rotated based on the orientation information to have a low-pass characteristic along the length of the edge, and a high-pass characteristic along the width of the edge.

6. The method according to claim 2, wherein
the edge information includes orientation information indicating an orientation of the edge; and
the control information includes correspondence information indicating a correspondence between an edge pixel and a non-edge pixel and used when the filter is applied to a target pixel after the edge pixel is replaced with the non-edge pixel, the edge pixel being neighboring on the target pixel, the edge pixel and the non-edge pixel being located symmetrical with respect to a length of the edge.

7. The method according to claim 2, wherein
the edge information includes intensity information indicating an intensity of the edge; and
the control information includes position information indicating a position of a singular pixel, the position information being used when the filter is applied to a target pixel after the singular pixel is replaced with the target pixel or a pixel neighboring on the target pixel based on the intensity information, a difference between the pixel value of the singular pixel and a pixel value of the target pixel being higher a threshold value.

8. The method according to claim 1, wherein
the edge information includes orientation information indicating an orientation of the edge; and
the control information includes rotation angle information indicating a rotation angle of the filter and used when the filter is rotated and applied based on the orientation information.

9. A moving image encoding apparatus comprising:
a prediction error generating unit configured to generate a prediction error image based on a difference between an input moving image and a predicted image;
a transform/quantization unit configured to execute transform and quantization on the prediction error image to generate a plurality of quantized transformation coefficients;
an edge information generating unit configured to generate edge information which indicates an attribute of an edge in a local decoded image corresponding to an encoded image;
a control information generating unit configured to generate, based on the edge information, control information associated with application of a filter to a decoded image at a decoding side;
a setting unit configured to set filter coefficients for the filter based on the control information; and
an encoding unit configured to encode the quantized transformation coefficients and filter coefficient information indicating the filter coefficients to output encoded data.

10. A moving image decoding method comprising:
decoding input encoded data to generate a plurality of quantized transformation coefficients and filter coefficient information indicating filter coefficients;
executing inverse-quantization and inverse-transform on the quantized transformation coefficients to generate a prediction error image;
generating a decoded image using the prediction error signal and a predicted image;
generating edge information indicating an attribute of an edge in the decoded image;
generating control information associated with application of a filter to the decoded image based on the edge information; and
applying, to the decoded image, the filter having the filter coefficients specified by the filter coefficient information based on the control information to generate a restored image.

11. The method according to claim 10, further comprising generating the predicted image using the restored image as a reference image.

12. The method according to claim 11, wherein
the edge information includes orientation information indicating an orientation of the edge; and
the control information includes rotation angle information indicating a rotation angle of the filter and used when the filter is rotated and applied based on the orientation information.

13. The method according to claim 11, wherein
the edge information further includes intensity information indicating an intensity of the edge; and
the rotation angle information included in the control information is used when the filter is rotated and applied to an area in which the intensity of the edge is higher than a threshold value based on the orientation information.

14. The method according to claim 12, wherein the filter is rotated based on the orientation information to have a low-pass characteristic along the length of the edge, and a high-pass characteristic along the width of the edge.

15. The method according to claim 11, wherein
the edge information includes orientation information indicating an orientation of the edge; and
the control information includes correspondence information indicating a correspondence between an edge pixel and a non-edge pixel and used when the filter is applied to a target pixel after the edge pixel is replaced with the non-edge pixel, the edge pixel being neighboring on the target pixel, the edge pixel and the non-edge pixel being located symmetrical with respect to a length of the edge.

16. The method according to claim 11, wherein
the edge information includes intensity information indicating an intensity of the edge; and
the control information includes position information indicating a position of a singular pixel, the position information being used when the filter is applied to a target pixel after the singular pixel is replaced with the target pixel or a pixel neighboring on the target pixel based on the intensity information, a difference between the pixel value of the singular pixel and a pixel value of the target pixel being higher a threshold value.

17. The method according to claim 10, further comprising outputting the restored image as an output image,
wherein
the edge information includes orientation information indicating an orientation of the edge; and
the control information includes rotation angle information indicating a rotation angle of the filter and used when the filter is rotated and applied based on the orientation information.

18. A moving image decoding apparatus comprising:
a decoding unit configured to decode input encoded data to generate a plurality of quantized transformation coefficients and filter coefficient information indicating filter coefficients;
an inverse-quantization and inverse-transform unit configured to execute inverse-quantization and inverse-transform on the quantized transformation coefficients to generate a prediction error image;
a decoded image generating unit configured to generate a decoded image using the prediction error signal and a predicted image;
an edge information generating unit configured to generate edge information indicating an attribute of an edge in the decoded image;
a control information generating unit configured to generate control information associated with application of a filter to the decoded image based on the edge information; and
a filter application unit configured to apply, to the decoded image, the filter having the filter coefficients specified by the filter coefficient information based on the control information to generate a restored image.
